(19) United States
(12) Patent Application Publication
(10) Pub. No.: US 2018/0135592 A1
(43) Pub. Date: May 17, 2018

(54) WIND TURBINE ROTOR BLADE

(71) Applicant: Wobben Properties GmbH, Aurich (DE)

(72) Inventors: Ralf MESSING, Aurich (DE); Harro HARMS, Wiesmoor (DE); Hendrik JANSSEN, Aurich (DE); Andree ALTMIKUS, Aurich (DE)

(21) Appl. No.: 15/564,419

(22) PCT Filed: Apr. 6, 2016
(86) PCT No.: PCT/EP2016/057467

§ 371 Date: Oct. 4, 2017

(30) Foreign Application Priority Data
Apr. 10, 2015 (DE) 10 2015 206 430.1

(51) Int. Cl. F03D 1/06

(52) U.S. Cl. CPC F03D 1/0616; F03D 1/0641

(57) ABSTRACT

A rotor blade of a wind power installation, comprising an inner section in which the rotor blade is fastened on a rotor hub, and an outer section, which is connected to the rotor blade and comprises a rotor blade tip. The rotor blade has at least partially a flat back profile having a truncated rear edge in the inner section, and at least one control unit for controlling the wake is provided on the rotor blade on the flat back profile.

### BACKGROUND

### Technical Field

The present invention relates to a wind power installation rotor blade and to a wind power installation. The present invention furthermore relates to a method for controlling a wake of a rotor blade of a wind power installation.

### Description of the Related Art

Wind power installations to be used for generating electricity are widely known, and are configured for example as in FIG. 1. In this case, the mechanical power drawn by the rotor from the wind depends inter alia on the configuration of the rotor blades. Increasing the amount of power drawn increases the efficiency and therefore the output of the wind power installation. One conventional measure for further increasing the output of wind power installations is to increase the rotor diameter. With increasing rotor diameters, the profile depths of the rotor blade in the hub region conventionally likewise increase. In the case of a large rotor diameter, the profile depths are in this case so great that problems may arise during transport in respect of predetermined maximum transport dimensions and in respect of transport logistics. In order to resolve this problem, the use of so-called flat back profiles is already known. In what follows, such a flat back profile is intended to mean a profile which is shortened because of a thick, i.e., truncated rear edge in the profile depth direction. By virtue of such flat back profiles, logistical specifications in respect of maximum transport dimensions can be taken into account. A disadvantage with such flat back profiles, however, is that beyond a certain relative profile thickness, compared with conventional profiles with the same relative profile thickness but a tapering, i.e., pointed rear edge, the lift coefficient is reduced and at the same time the resistance coefficient is increased. This leads to a deterioration of the aerodynamic performance coefficient of the rotor blade and therefore to output losses of the wind power installation.

The wind flows around the rotor blade. This flow is affected by friction. The friction gives rise to a region of shed flow behind the rotor blade, the so-called wake. In the wake, vortices which have an effect on the output performance of the wind power installation are formed. The wake, and therefore also the number and size of vortices, in this case depend on the configuration of the profile of the rotor blade. A small wake is favorable for the output performance of the wind power installation. Precisely in the case of the above-described flat back profiles, or in the case of somewhat rounded cross sections as are partially used in the region of the rotor hub, a large wake occurs and correspondingly also large output losses of the wind power installation.

“Moving surface boundary-layer control: A Review”, V. J. Modi, Journal of Fluids and Structures (1997), Volume 11, pages 627-663 describes the use of rotating rollers in the case of a wing, or a profile. The rollers rotate in the flow direction and may be provided on the front edge, the rear edge and an upper side of the profile.

The German Patent and Trade Mark Office has investigated the following prior art in the German patent application on which the priority is based: DE 10 2013 204 879 A1, DE 101 52 449 A1, DE 10 2011 012 965 A1, DE 103 48 060 A1 and DE 10 2007 059 285 A1.

### BRIEF SUMMARY

Provided is a solution by which an output loss of wind power installations having rotor blades with flat back profiles or with essentially round cross sections can be reduced greatly, or in particular even avoided.

A rotor blade comprises an inner section in which the rotor blade is fastened on a rotor hub, and an outer section, which comprises a rotor blade tip. The inner section can be fastened to the outer section. The rotor blade has at least partially a flat back profile having a truncated rear edge in the inner section, and at least one flow control unit for controlling the wake is provided on the rotor blade on the flat back profile. The inner section of the rotor blade may in this case have the greatest profile depth of the rotor blade overall. It extends in particular from the rotor blade root, i.e., the region of connection to the rotor blade hub, to approximately the middle of the rotor blade.

In the inner section, the rotor blade partially has a flat back profile, i.e., a profile which is shortened in the profile depth direction and has a thick rear edge. The thickness of the rear edge is preferably more than 0.5 m, and in particular it lies in a range of from 0.7 m to 5 m. Such a flat back profile advantageously takes into account logistical specifications in respect of maximum transport dimensions. Furthermore, a load reduction in component-dimensioning load cases with strong wind is taken into account because of the reduced profile depth.

In order to cause no output losses of the wind power installation, the rotor blade comprises at least one flow control unit in the inner section for controlling the wake on the rotor blade. Such a control unit is configured in the form of moved walls or elements on the rotor blade surface. Because of the moved walls, the flow is moved, or accelerated, particularly on the rear edge of the flat back profile. In particular, the flow is deviated in the direction of the profile chord. The profile chord is in this case intended to mean a virtual straight line which extends through the front edge and the rear edge. In this way, a reduction of the wake is achieved with generally increasing lift coefficients and reduced resistance coefficients of the rotor blade. Advantageously, significant increases in the lift coefficients can be achieved in combination with a considerable increase in the critical attitude angle of the profile when flow shedding takes place. By using such a control unit for flat back profiles, it is therefore possible to achieve lift coefficients as in the case of conventional profiles with larger profile depths, and therefore to avoid output losses of the wind power installation occurring because of blade depth reduction. Furthermore, the profile properties, i.e., lift and resistance coefficients, can be influenced by means of the control unit. New possibilities are thereby provided for the rotor blade configuration and the converter regulation. Such a combination of flat back profiles with at least one control unit therefore combines the advantages of flat back profiles with those of the conventional profiles of rotor blades, namely compliance with maximum transport dimensions of the rotor blade with, at the same time, at least an equal performance of the wind power installation as in the case of a conventional profile.

Preferably, the control unit comprises at least one cylindrical body having a longitudinal axis, and the at least one cylindrical body can be rotated about the longitudinal axis. By the rotational movement of the at least one cylindrical body about its longitudinal axis, the flow at this position is moved, or accelerated. The wake is reduced, so that the lift coefficient is increased. In particular, a plurality of cylindrical bodies, which either respectively have a longitudinal axis and/or a common longitudinal axis, are provided on the flat back profile. Such a cylindrical body is configured, in particular, as a hollow cylinder. The size of such a cylindrical body varies, in particular, over the span width of the rotor blade.

In one particularly preferred embodiment, the control unit comprises at least one first cylindrical body having a first longitudinal axis and at least one second cylindrical body having a second longitudinal axis, and the at least one first cylindrical body can be rotated about the first longitudinal axis and the at least one second cylindrical body can be rotated about the second longitudinal axis, and the first cylindrical body and the second cylindrical body are connected by means of a conveyor belt for moving an incident flow flowing around the flat back profile. The conveyor belt is, in particular, provided on the outer surfaces of the first and second cylindrical bodies, in such a way that the conveyor belt is moved around the first and second cylindrical bodies. The conveyor belt thus encloses the first and second cylindrical bodies. The flow sticks to the conveyor belt and is thus accelerated, or entrained, by the conveyor belt. The flow is thereby deviated in the direction of the profile chord. This leads to a reduced wake. The lift coefficient can thereby be increased.

The first longitudinal axis is in this case arranged before the second longitudinal axis in the profile depth direction, i.e., in particular between the truncated rear edge and the second longitudinal axis, and/or the first longitudinal axis is arranged on an upper side of the profile and the second longitudinal axis on a lower side of the profile. The first and second cylindrical bodies can in this case be rotated in and/or counter to the flow direction. Correspondingly, the conveyor belt can be rotated in and/or counter to the flow direction.

Preferably, the at least one control unit is provided on the truncated rear edge. By arrangement of the control unit on the rear edge of a flat back profile, the flow is moved, or accelerated, in particular on the rear edge. In this way, the flow is diverted toward the profile chord. Abrupt flow shedding at the rear edge of the profile is thereby avoided, and a large wake is therefore also avoided. A significant increase in the lift coefficients can thereby be achieved, in combination with an increase in the critical attitude angle when the flow shedding takes place. Output losses of the wind power installation are avoided.

In one preferred embodiment, the at least one cylindrical body, or the first and/or second cylindrical body, can be rotated in and/or counter to a flow direction. The flow occurring on the cylindrical body is thereby taken up and correspondingly accelerated, so that flow shedding at the profile is delayed and the wake is reduced. The lift coefficient of the rotor blade is thereby increased, and the resistance coefficient is reduced. Furthermore, the at least one cylindrical body, or the first and/or second cylindrical body, can be used flexibly.

In one particularly preferred embodiment, the control unit is integrated into the rotor blade. Such a rotor blade in this case has cladding, also referred to as an outer skin, on the upper side and the lower side. Such an outer skin delimits an inner cavity and defines the outer contour of the profile of the rotor blade. The control unit is integrated into this outer skin, or cladding. Accordingly, the rotor blade is constructed in such a way that cladding is initially provided on the profile of the rotor blade, particularly on the upper side and/or the lower side, the control unit is arranged in a further section, and cladding is again arranged in a next section. The control unit is accordingly provided between the outer skin, or the cladding, in such a way that it comes in contact with the incident wind flow in order to entrain or accelerate it in the vicinity of the wall. In this way, the control unit is substantially protected from environmental influences and can furthermore achieve movement, or acceleration, of the flow on the surface of the profile.

Preferably, the at least one control unit is provided on an upper side and/or a lower side of the flat back profile. The incident flow strikes the upper and lower sides of the flat back profile. These respectively correspond to the negative and positive pressure sides of the profile. The control unit then deviates the flow at this position and moves, or accelerates, it in such a way that premature flow shedding and therefore a large wake are avoided. In order to deviate the flow better in the direction of the profile chord, a guide plate is provided in particular between the rear edge of the flat back profile and the control unit. The guide plate already deviates the flow in the direction of the control unit. The latter entrains the flow and deviates it further in the direction of the profile chord, so that a large wake is avoided.

In one preferred embodiment, a plurality of cylindrical bodies are arranged on the flat back profile in the span width direction of the rotor blade. In this case, at least some of the cylindrical bodies have a different diameter from one another and/or a different length from one another. The plurality of cylindrical bodies, i.e., at least two cylindrical bodies, are accordingly arranged at different positions on the rotor blade, in particular at different positions between the rotor blade root and the rotor blade tip. At least some of the plurality of cylindrical bodies in this case have a different diameter from one another and/or a different length. Accordingly, for example, a cylindrical body arranged close to the rotor blade root has a different diameter and/or a different length from a cylindrical body arranged close to the middle of the rotor blade. Depending on the flow conditions, or the configuration of the rotor blade profile, the diameters of the cylindrical bodies are adapted accordingly. Thus, some of the cylindrical bodies may have the same diameters and lengths, whereas other cylindrical bodies have a different diameter or length therefrom. The flow in the vicinity of the wall, or flow on the rear edge, can therefore be entrained or accelerated optimally.

The plurality of cylindrical bodies are, in particular, configured as hollow cylinders. In particular, they are arranged on a common shaft.

In one particularly preferred embodiment, at least some of the plurality of cylindrical bodies can be rotated with a different rotation speed from one another. The flow on the rotor blade has a different speed in the root region than at the rotor blade tip. The cylindrical bodies may be rotated with different rotational speeds according to the different speeds, so that the flow can experience an acceleration which is optimal for the corresponding position on the rotor blade.

A rotor blade of a wind power installation is preferably provided, having an inner section, in which the rotor blade is fastened on a rotor hub, and an outer section, which comprises a rotor blade tip. The rotor blade is characterized in that a root region which has an essentially circular cross section is provided in the inner section, and wherein at least one control unit for controlling the wake is provided on the rotor blade in the essentially circular cross section. In such a circular cross section in the root region, i.e., in the region of direct connection of the rotor blade to the rotor hub, the output losses of a wind power installation due to large vortex generation are considerable. With the arrangement of at least one control unit, the flow in the inner region can be controlled, and the wake can therefore also be controlled. In this way, the lift coefficient is increased at the essentially circular cross section and the resistance coefficient is reduced.

In order to achieve the object, a wind power installation having a tower, a nacelle which is mounted so that it can rotate on the tower, a rotor mounted so that it can rotate on the nacelle, and a multiplicity of rotor blades fastened on the rotor, at least one of which is configured according to the embodiment described above, is furthermore provided. The advantages mentioned above are thereby achieved in the same way.

Furthermore, in order to achieve the object, a method for controlling a wake of a rotor blade according to one of the embodiments described above is provided. The method comprises moving an incident flow striking the rotor blade by means of at least one flow control unit in such a way that the wake is reduced. Because of the wind, there is in this case an incident flow of the wind on the individual rotor blades. The incident flow flows around the profile. Because of the at least one control unit, the incident flow is entrained, or accelerated, so that flow shedding is delayed until further behind in the profile depth direction. As a result, the lift coefficient is increased, the resistance coefficient is decreased and the wake is reduced. The efficiency or output of a wind power installation is increased.

Preferably, the control unit rotates with a predetermined circumferential speed. Here, the circumferential speed is intended to mean the speed on the outer line of the control unit. Because of the rotational movement of the control unit, the flow on the rotor blade near the wall is entrained and accelerated. Depending on the wind conditions or installation sites and/or rotor diameter of the wind power installation, in order to achieve an optimal result it is expedient to adapt the circumferential speed to these conditions.

### BRIEF DESCRIPTION OF THE SEVERAL VIEWS OF THE DRAWINGS

The invention will be explained by way of example below with the aid of exemplary embodiments with reference to the appended figures. The figures sometimes contain simplified schematic representations.

FIG. 1 shows a wind power installation in a perspective view,

FIG. 2 shows a cross section of a rotor blade according to the prior art,

FIG. 3 shows a detail of a rotor blade according to the invention,

FIG. 4 shows the cross section of the flat back profile,

FIG. 5 shows an exemplary embodiment of a flat back profile according to the invention with a flow control unit,

FIG. 6 shows another exemplary embodiment of a flat back profile according to the invention,

FIG. 7 shows another exemplary embodiment of a flat back profile according to the invention,

FIG. 8 shows another exemplary embodiment of a flat back profile according to the invention,

FIG. 9 shows another exemplary embodiment of a rotor blade according to the invention,

FIG. 10 shows a cross section of the rotor blade of FIG. 9, and

FIG. 11 shows a cross section of a rotor blade according to one aspect of the invention.

### DETAILED DESCRIPTION

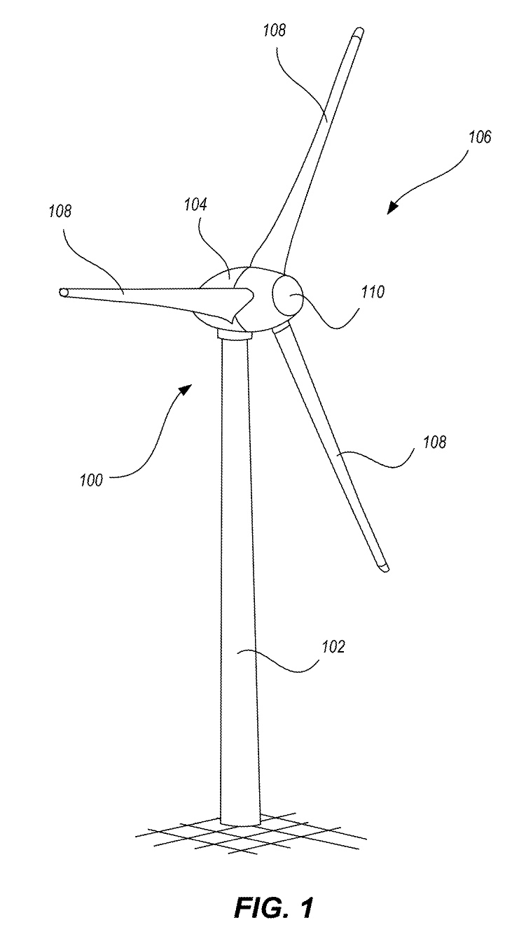

FIG. 1 shows a wind power installation 100 with a tower 102 and a nacelle 104. A rotor 106 having three rotor blades 108 and a spinner 110 is arranged on the nacelle 104. The rotor 106 is set in a rotational movement by the wind during operation, and thereby drives a generator in the nacelle 104.

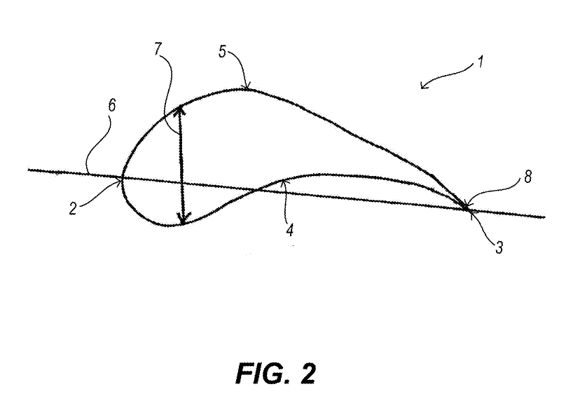

FIG. 2 shows a cross section of a profile 1 of a rotor blade of a wind power installation according to the prior art. Such a cross section comprises a front edge 2 and a rear edge 3. At the rear edge 3, the lower side 4 and the upper side 5 meet one another. The rear edge 3 converges acutely and shallowly. The rear edge thickness 8 i.e. the thickness of the profile 1 at the rear edge 3 is almost zero. The maximum profile thickness 7 of the profile 1 is arranged in the direction of the front edge 2. Furthermore, the profile chord 6, which extends from the front edge 2 to the rear edge 3, is represented in FIG. 2.

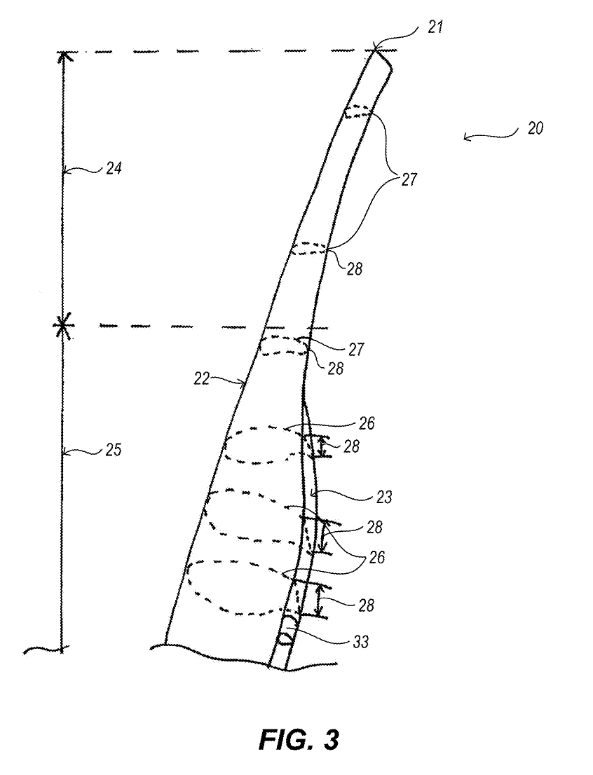

FIG. 3 shows a detail of a rotor blade 20. The rotor blade 20 is divided into an inner section 25 and an outer section 24. The outer section 24 comprises a rotor blade tip 21. The connection to the rotor blade hub in the inner section 25 is not represented in this case. Various cross sections or profiles 26, 27 are represented in the rotor blade 20 in FIG. 3. Three flat back profiles 26 and one conventional profile 27 are represented in the inner section 25. Two conventional profiles 27 can be seen in the outer section 24. The flat back profiles 26 have a profile thickness 28 at the rear edge 23 which is greater than zero, and in particular lies in the range of from 0.5 to 5 m. The conventional profiles 27 taper shallowly and acutely at the rear edge 23, and correspondingly have a thickness 28 of almost zero at the rear edge 23. In the rotor blade 20, a (flow) control unit for controlling the wake is in this case provided in the form of a cylindrical roller 33 at the rear edge 23. Such a rotor blade complies in particular with the maximum transport dimensions specified for transport. Furthermore, it can generate at least the same power as a rotor blade with a conventional profile, as shown by way of example in FIG. 2.

As an alternative, a plurality of (flow) control units may be provided on such a flat back profile. The plurality of control units in this case vary particularly in respect of the diameter, their length and/or rotational speed.

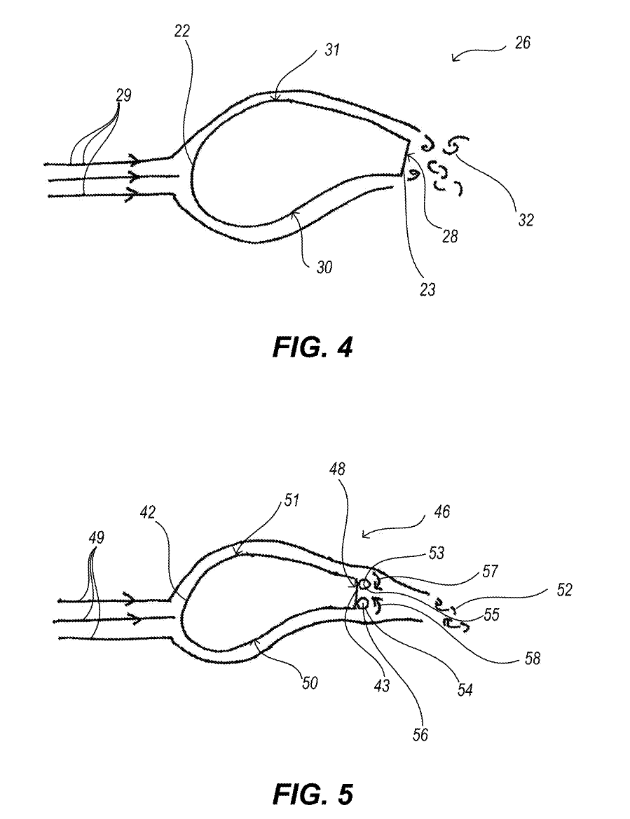

FIG. 4 shows the cross section of a flat back profile 26 without a (flow) control unit. The flat back profile 26 has a truncated rear edge 23 with a large rear edge thickness 28. An incident flow 29 of the wind strikes the flat back profile 26. At the front edge 22, the incident flow 29 is divided and flows around the flat back profile 26 on the lower side 30 and the upper side 31. The incident flow in this case bears on the upper side 31 and the lower side 30. Behind the rear edge 23 in the direction of the profile depth, the incident flow 29 is she. Vortices 32 are formed, which create a wake at the rotor blade. Because of this, the lift coefficient of the flat back profile 26 is reduced and the resistance coefficient is increased. The performance of the wind power installation overall is reduced.

FIG. 5 shows a cross section of a rotor blade. The cross section is in this case configured as a flat back profile 46. The flat back profile 46 comprises a front edge 42 and a rear edge 43, as well as an upper side 51 and a lower side 50. The rear edge 43 has a large rear edge thickness 48. An incident flow 49 flows around the flat back profile 46. The incident flow 49 is divided at the front edge 42, in order again to flow on the upper side 51 and the lower side 50. At the rear edge 43, a first roller 53 and a second roller 54 are provided as an exemplary embodiment of a (flow) control unit. The first roller 53 is arranged on the upper side 51, and the second roller 54 is arranged on the lower side 50. The first roller 53 has a first longitudinal axis 55, and the second roller 54 has a second longitudinal axis 56. The first roller 53 can be rotated about the first longitudinal axis 55, and the second roller 54 can be rotated about the second longitudinal axis 56. The rotation directions are represented by an arrow 57 and 58, respectively. The first roller 53 and the second roller 54 accordingly each rotate in the direction of the flow of the flat back profile 46 being flowed around. The rotation direction of the first and second rollers 53, 54 may, however, also take place in the clockwise direction, i.e., one roller rotates in the direction of the flow and one counter to the flow. In this way, the incident flow 49 is taken up by the first roller 53 or the second roller 54, respectively, and is therefore moved or accelerated. The wake is reduced. Fewer and smaller vortices 52 are formed in the region of the rear edge 43. The lift coefficient of the rotor blade is thereby increased and the resistance coefficient is reduced. An increase in the output of the wind power installation is therefore achieved.

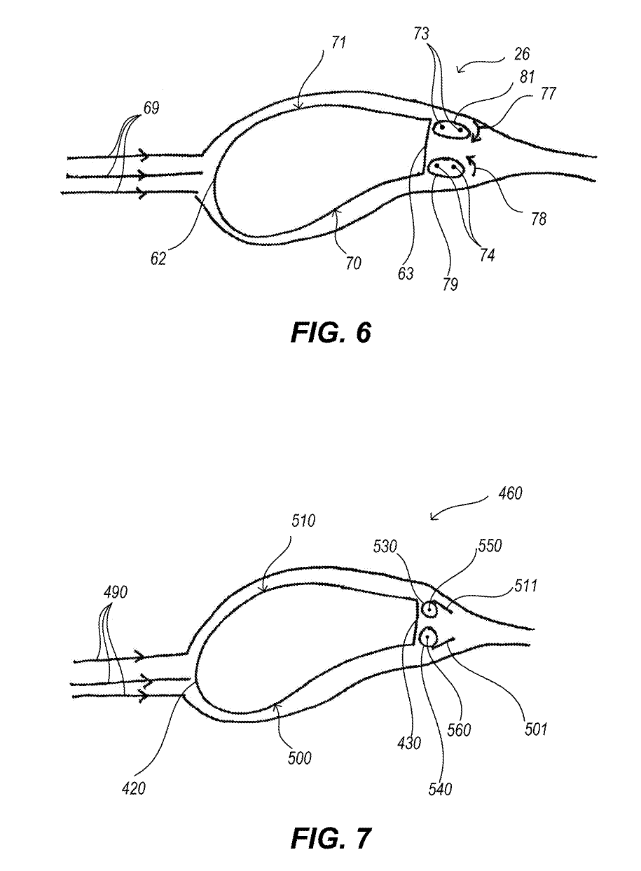

FIG. 6 shows another exemplary embodiment of a cross section of a flat back profile 66 of a rotor blade of a wind power installation. An incident flow 69 flows around the flat back profile 66. The flat back profile 66 comprises an upper side 71 and a lower side 70, as well as a truncated rear edge 63 and a front edge 62. In contrast to FIG. 5, a first conveyor belt 81 and a second conveyor belt 79 are provided at the rear edge 63 as an exemplary embodiment of a (flow) control unit. The first conveyor belt 81 and the second conveyor belt 79 enclose a first roller pair 73 and a second roller pair 74, respectively, each comprising two rollers arranged in the profile depth direction. The first conveyor belt 81 and the second conveyor belt 79 connect to one another the two rollers of the first roller pair 73 and the two rollers of the second roller pair 74, respectively. The first conveyor belt 81 is arranged on the upper side 81, and the second conveyor belt 79 is arranged on the lower side of the rear edge 63 of the flat back profile 66. The incident flow 69 is moved by the first conveyor belt 71 and the second conveyor belt 79, respectively. The wake is thereby reduced.

FIG. 7 shows another embodiment of a cross section of a rotor blade of a wind power installation. The cross section is configured as a flat back profile 460. The flat back profile 460 comprises a front edge 420 and a rear edge 430, as well as an upper side 510 and a lower side 500. An incident flow 490 flows around the flat back profile 460. The incident flow 490 is divided at the front edge 420 in order to flow around the upper side 510 and the lower side 500. In contrast to the flat back profile represented in FIG. 5, a first roller 530 and a second roller 540 are integrated into the rotor blade as an exemplary embodiment of a (flow) control unit, i.e., the first roller 530 and the second roller 540 are not provided as a termination on the rear edge 430. The first roller 530 and the second roller 540 are arranged behind the rear edge 430, first cladding 511 and second cladding 501 respectively also being provided behind the first roller 530 and the second roller 540. The first roller 530 and the second roller 540 are therefore at least partially contained in the flat back profile 460. The first roller 530 and the second roller 540 move the incident flow 490 but are nevertheless for the most part protected from environmental influences. The first roller 530 and the second roller 540 therefore have a long lifetime. The wake is also reduced in its extent in this exemplary embodiment. This exemplary embodiment therefore also has the advantages mentioned above.

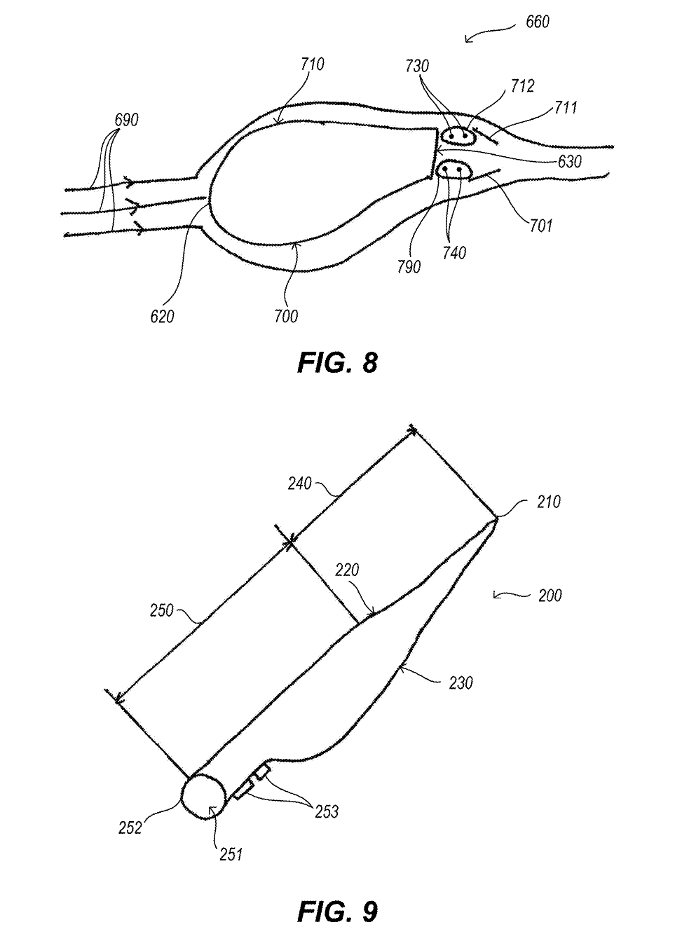

FIG. 8 shows another embodiment of a cross section of a rotor blade of a wind power installation. An incident flow 690 flows around the flat back profile 660. The flat back profile 660 comprises an upper side 710 and a lower side 700, as well as a truncated rear edge 630 and a front edge 620. A first conveyor belt 712 and a second conveyor belt 790 are provided on the rear edge 630. The first conveyor belt 712 and the second conveyor belt 790 enclose a first roller pair 730 and a second roller pair 740, each comprising two rollers arranged in the profile depth direction. The first conveyor belt 712 and the second conveyor belt 790 are respectively integrated into the rotor blade. First cladding 711 and second cladding 701 are respectively provided behind the first conveyor belt 712 and the second conveyor belt 790. The first roller 730 and the second roller 740 are therefore at least partially contained in the flat back profile 660.

FIG. 9 shows another exemplary embodiment of a rotor blade 200. The rotor blade 200 comprises a front edge 220 and a rear edge 230, as well as an inner section 250 and an outer section 240. The root region 251 of the rotor blade 200, i.e., the region in which the rotor blade 200 is connected to the rotor blade hub, is provided in the inner section 250. The root region 251 has a round cross section 252. The outer section 240 extends approximately from half-way along the rotor blade 200 to the rotor blade tip 210. Two first rollers 253 are provided as an exemplary embodiment of two control units on the round cross section 252. The two first rollers 253 are in this case configured cylindrically.

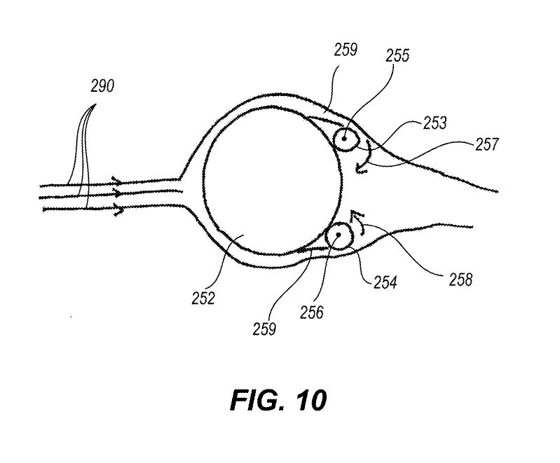

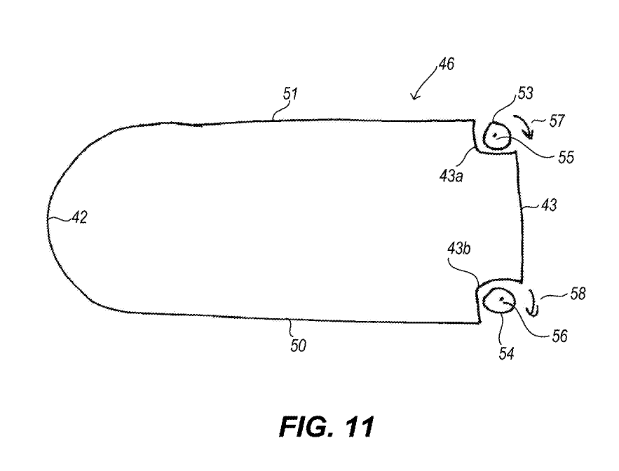

FIG. 10 shows the round cross section 252 of the rotor blade 200 of FIG. 9. An incident flow 290 of the wind flows around the round cross section 252. A first roller 253 and a second roller 254 are arranged on one side of the round cross section 252. The first roller 253 has a first longitudinal axis 255, and the second roller 254 has a second longitudinal axis 256. The first roller 253 and the second roller 254 rotate in the direction of the arrow 257 or 258, respectively, i.e., in the direction of the incident flow 290. As a result, the wake is decreased, vortex generation is reduced and, consequently, the lift coefficient is increased and the resistance coefficient is reduced. The output of the wind power installation is therefore increased. As an alternative thereto, the first and second rollers 253, 254 may respectively rotate in the clockwise direction, i.e., the first roller 253 rotates with the flow and the second roller 254 rotates counter to the flow.

FIG. 10 furthermore shows two guide plates 259, which connect the round cross section 252 to the first roller 253 and the second roller 254, respectively. Because of the guide plates 259, the flow is deviated in the direction of the first roller 253 and the second roller 254, respectively. The flow is thereby deviated from the outer sides of the round cross section toward the middle. The flow is controlled, and the wake is correspondingly also controlled.

FIG. 11 shows a schematic cross section of a wind power installation rotor blade according to another exemplary embodiment. The cross section is configured here as a flat back profile 46. The flat back profile comprises a front edge 42 and a rear edge 43, as well as an upper side 51 and a lower side 50. The rear edge 43 comprises a first and a second recess 43a, 43b. A first roller 53 is provided in the region of the first recess 43a, and a second roller 54 is provided in the region of the second recess 43b. The first roller 43 has a first longitudinal axis 55, and the second roller 54 has a second longitudinal axis 56. The first roller 53 is rotatable around the first longitudinal axis 55 and the second roller 54 is rotatable around the second longitudinal axis 56. The rotation directions are respectively represented by an arrow 57, 58. According to this aspect, the rotation directions of the first and second rollers are the same. This therefore means that the first roller rotates in the flow direction, while the second roller 54 rotates counter to the flow direction. According to this aspect, the first and second rollers 53, 56 are provided in the first and second recesses 43a, 43b in such a way that the first and second rollers are provided within an imaginary extended contour of the upper and lower sides 51, 50.

The first and second rollers are therefore embedded in the profile contour of the rotor blade by the rollers being provided in the region of the first and second recesses.

Flow control is provided by the provision of the first and second rollers and of the corresponding rotation directions.

According to one aspect, the first and second rollers 53, 54, 253, 254 are arranged in the region of the flat back profile in such a way that they do not protrude beyond the extended rear edge profile contour. In other words, if the rotor blade were not provided with a flat back profile, then the rollers would have to lie within the contour of the imaginary rear edge. The two rollers therefore lie within an imaginary contour of the rear edge when this rear edge is extended with the present gradient.

By virtue of such an arrangement, it is possible to provide a rotor blade having a high lift coefficient.

1. A wind power installation rotor blade comprising:
an inner section having an end configured to fasten the rotor blade to a rotor hub; and
an outer section including a rotor blade tip,
wherein at least a portion of the inner section includes:
a flat back profile having a truncated rear edge, and
at least one flow control unit for actively controlling a wake provided on the rotor blade at the flat back profile,
wherein the at least one flow control unit comprises at least one cylindrical body having a longitudinal axis, the at least one cylindrical body configured to be rotated about the longitudinal axis, and
wherein the at least one flow control unit is provided on the truncated rear edge.

2. The wind power installation rotor blade of claim 1, wherein the at least one cylindrical body is a plurality of cylindrical bodies, each having a longitudinal axis wherein each cylindrical body of the plurality of cylindrical bodies are configured to be rotated about their respective longitudinal axis.

3. The wind power installation rotor blade of claim 2, wherein the plurality of cylindrical bodies are coupled together by a conveyor belt for moving an incident flow flowing around the flat back profile.

4. The wind power installation rotor blade of claim 1, wherein the at least one cylindrical body is configured to be rotated in and counter to an incident flow direction.

5. The wind power installation rotor blade of claim 1, wherein the at least one flow control unit is integrated into the rotor blade.

6. The wind power installation rotor blade of claim 1, wherein the truncated rear edge comprises a recess configured to receive the at least one cylindrical body.

7. The wind power installation rotor blade of claim 1, wherein the at least one flow control unit is provided on one of the upper side or the lower side of the flat back profile.

8. The wind power installation rotor blade of claim 1, wherein a plurality of cylindrical bodies are arranged on the flat back profile in a span width direction of the rotor blade, at least some of the cylindrical bodies having at least one of a different diameter from one another or a different length from one another.

9. The wind power installation rotor blade of claim 9, wherein at least some of the plurality of cylindrical bodies can be rotated with a different rotation speed and rotation direction from one another.

10. A wind power installation rotor blade comprising:
an inner section including a root section configured to fasten the rotor blade to a rotor hub, wherein the root region has a cross section that is substantially circular;
an outer section including a rotor blade tip; and
at least one flow control unit for actively controlling a wake, the at least one flow control unit being provided on the rotor blade at the cross section,
wherein the at least one flow control unit comprises a cylindrical body having a longitudinal axis, wherein the cylindrical body is configured to be rotated about the longitudinal axis.

11. A wind power installation comprising:
a tower;
a nacelle mounted to the tower so that the nacelle is configured rotate relative to the tower;
a rotor mounted to the nacelle so that the rotor is configured to rotate relative to the nacelle; and
a plurality of rotor blades coupled to the rotor, at least one of the rotor blades being the wind power installation rotor blade of claim 1.

12. A method for controlling a wake of a wind power installation rotor blade comprising:
moving an incident flow striking the rotor blade by using at least one flow control unit in such a way that the wake is reduced, the at least one flow control unit being located at a flat back profile of an inner section of the rotor blade.

13. The method as claimed in claim 12, comprising rotating the at least one flow control unit with a predetermined circumferential speed.
